(19) United States
(12) Patent Application Publication
(10) Pub. No.: US 2026/0084059 A1
(43) Pub. Date: Mar. 26, 2026

(54) PERSONALIZED DISPLAYS FOR DRIVERS AND SPECTATORS

(71) Applicants: Ivan Mauricio Buritica Suarez, Weston, FL (US); Duvan Felipe Perez Rodriguez, Bogota (CO)

(72) Inventors: Ivan Mauricio Buritica Suarez, Weston, FL (US); Duvan Felipe Perez Rodriguez, Bogota (CO)

(73) Assignee: Ivan Mauricio Buritica Suarez, Weston, FL (US)

(21) Appl. No.: 18/896,257

(22) Filed: Sep. 25, 2024

(51) Int. Cl. A63F 13/65; A63F 13/211; A63F 13/537; A63F 13/58; A63F 13/77; A63F 13/86

(52) U.S. Cl. CPC A63F 13/65; A63F 13/211; A63F 13/537; A63F 13/58; A63F 13/77; A63F 13/86

(57) ABSTRACT

The present invention discloses a gaming system that revolutionizes the gaming experience by incorporating personal screens within helmets or go-karts or other vehicles, offering players immersive access to vital information and fostering dynamic interaction. These screens, equipped with LED displays, showcase player attributes, facilitate communication, and present the player's assumed gaming name for easy identification. The system integrates physical and digital elements, providing a seamless fusion of real-world parameters with digital aspects to enhance realism and engagement. Modular design allows players to customize displayed information, while sensors detect physical impacts, adding depth to gameplay. Interactive elements enable communication and trigger in-game actions, while synchronization across devices ensures fairness. With power-up interactions, intuitive interfaces, and spectator modes enhancing audience participation, the gaming system represents a groundbreaking advancement in gaming technology, offering players an unparalleled level of immersion and excitement.

### TECHNICAL FIELD

The present invention relates to the field of electronic gaming, and more particularly to a gaming system designed to replicate an electronic game within a physical gaming environment with a dynamic display.

### BACKGROUND

The following description includes information that may be useful in understanding the present invention. It is not an admission that any of the information provided herein is prior art or relevant to the presently claimed invention, or that any publication specifically or implicitly referenced is prior art.

In the ever-evolving landscape of technological innovation, one field that continually captures the imagination of enthusiasts and professionals alike is the realm of interactive gaming and immersive experiences. From traditional video games to augmented reality applications, the demand for engaging and dynamic gaming environments has grown exponentially in recent years. However, while advancements in digital gaming have brought about unprecedented levels of immersion and interactivity, there remains a distinct gap between the virtual and physical worlds.

Existing gaming systems often rely on static displays or limited interfaces to convey information to players and spectators. In traditional racing games, for instance, vital statistics such as player status, position in the race, and available power-ups are typically presented on a static screen, offering little in the way of personalization or real-time engagement. Similarly, spectators are often left with a passive viewing experience, lacking the ability to interact with the game or fully immerse themselves in the action.

Moreover, in competitive gaming environments such as go-kart racing or eSports competitions, the need for real-time information exchange between players and spectators is particularly acute. Players require immediate access to critical data to inform their strategies and decision-making, while spectators seek a more interactive and engaging viewing experience that allows them to follow the action closely and feel connected to the game.

Presently, some innovations in the field of gaming technology, aim to push the boundaries of traditional gaming experiences by bridging the gap between digital and physical worlds. WO 2020/075099A1 patent describes a system and method for emulating electronic games in a physical gaming environment. It outlines a technology that enables players to interact with digital games in a physical space, possibly through the use of augmented reality, projection mapping, or other immersive technologies. The goal is to create a more engaging and interactive gaming experience by blending digital gameplay elements with physical surroundings.

U.S. Pat. No. 10,912,995 B2 describes a system and method for emulating electronic games in a physical gaming environment. It might offer a unique approach or specific features not covered by the previous patent. Like the above patent, it aims to provide players with a more immersive and interactive gaming experience by integrating digital games into physical spaces.

Further, the gaming system is further enhanced with additional features to create a comprehensive and immersive gaming experience. This system includes a computing arrangement connected to an environmental unit and one or more gaming devices, all spatially localized within a physical gaming environment. The goal is to emulate an electronic game within this physical setting, allowing users to engage with the game in a more tangible and interactive manner. Within this setup, the gaming devices are equipped with sensing arrangements to capture user inputs during gameplay, generating corresponding events. Similarly, the environmental unit is equipped with sensing arrangements to monitor the gaming devices and generate events associated with their interactions. These events are then processed by a central computing arrangement, which implements a set of rules to determine modifications to various parameters of the gaming system based on the game's rules and current status. Crucially, these modifications are designed to enhance competitiveness and improve the user experience. Programmable compensation rules allow for hardware reconfiguration of the gaming system in response to the game's status, ensuring that players remain challenged and engaged. The computing arrangement generates commands to implement these modifications, adjusting parameters in both the gaming devices and the environmental unit to compensate for any discrepancies and optimize the gaming experience for players. Additionally, the computing arrangement predefines sets of parameters for the gaming devices and the environmental unit, enabling them along with the sensing arrangements to be activated in a standby mode before the start of the electronic game. This ensures that the gaming system is fully prepared and operational when gameplay commences, providing players with a seamless and immersive gaming experience from the outset.

Recognizing the limitations of existing gaming systems and the growing demand for personalized, immersive experiences, there arises a compelling need for innovative solutions that bridge the gap between the digital and physical worlds. By harnessing cutting-edge technology and creative design principles, the invention seeks to revolutionize the way information is presented and exchanged in gaming environments, particularly in the context of competitive racing and eSports.

In light of these challenges and drawbacks, there exists a compelling opportunity for innovative solutions that address the limitations. As a result, there exists a need for improvements over the prior art and more particularly for a more efficient way.

### SUMMARY OF THE INVENTION

This invention introduces a revolutionary approach to gaming by integrating personalized screens into helmets or go-karts or other vehicles, thereby offering players and spectators real-time access to critical information during competitive racing events or eSports competitions. These dynamic displays serve as a conduit for transmitting vital statistics such as player status, position in the race, available power-ups, and other relevant data, empowering players to make informed decisions and strategize effectively in the heat of the moment.

Central to the invention is its ability to transform the gaming experience from passive observation to active engagement, both for players and spectators. By providing players with personalized screens that deliver instantaneous feedback and insights into their performance, the invention enhances immersion and interactivity, enabling players to optimize their gameplay and react dynamically to changing circumstances on the track. Furthermore, by extending this dynamic display to spectators, the invention bridges the gap between the gaming environment and the audience, fostering a deeper level of engagement and connection. Spectators are no longer mere observers but active participants in the gaming experience, able to follow the action closely and feel a sense of involvement as they track the progress of their favorite players and anticipate key moments in the race or battle.

Beyond its immediate applications in competitive gaming, the invention holds the potential to revolutionize the broader landscape of interactive entertainment and immersive experiences. Its innovative approach to information dissemination and user engagement opens up new possibilities for enhancing the gaming experience across a wide range of contexts, from theme parks and entertainment venues to home gaming setups and virtual reality environments.

In a game setting, players often wear helmets or sit in go-karts or other vehicles equipped with personal screens, like LED, displays, or status lights. These screens or lights show important details like how many lives a player has left, what special powers they possess, or any kind of benefit or penalty and their current position in the race. They also indicate if a player faces penalties, such as being temporarily slowed down or disabled after being shot by another player. The screen or status light displays effects of being disabled and shows the time remaining in this state. Additionally, players'gaming names are shown, helping others recognize them even if they're unfamiliar. This setup changes the game dynamic significantly, as it empowers players to strategize based on their resources and circumstances, like remaining lives or available car battery. These screens, referred to as “flags,” serve as a means of communication among players and the audience. The term “Phygital” reflects the blend of physical aspects like speed and bumps with digital elements such as power-ups and status indicators. For example, if one player has a defensive power-up while another has an offensive one, each player must tactically decide when to utilize their respective abilities. In a scenario with several players, if one obtains a “ray” power-up capable of disabling other players'cars, or “boost” power-up doubling your speed, spectators anticipate its usage and potential impact on the race's outcome. Similarly, acquiring a “shield” power-up might protect you from others attacks and enable a player to take a shortcut, altering their position and race dynamics or the effect in a deathmatch scenery where the last live is crucial in the multi-player game to define their rank or position. By providing spectators access to such information, they become more engaged and gain a deeper understanding of the ongoing game, surpassing traditional methods.

The summary of the invention does not necessarily disclose all the features essential for defining the invention. The invention may reside in a sub-combination of the disclosed features. The various combinations and sub-combination are fully described in the detailed description.

### BRIEF DESCRIPTION OF DRAWINGS

The accompanying drawings are included to provide a further understanding of the present disclosure and are incorporated in and constitute a part of this specification. The drawings illustrate exemplary embodiments of the present disclosure and, together with the description, serve to explain the principles of the present disclosure.

The diagrams are for illustration only, which thus is not a limitation of the present disclosure, and wherein:

FIG. 1 illustrates various components of the gaming system, in accordance with a preferred embodiment of the invention.

FIG. 2 is a flowchart depicting key characteristics of the gaming system, in accordance with a preferred embodiment of the invention.

FIG. 3 is a flowchart depicting the process of nutrient monitoring and adjustment (for the plants only) within the aquaponics system, in accordance with a preferred embodiment of the invention.

### DETAILED DESCRIPTION OF DRAWINGS

The following is a detailed description of embodiments of the disclosure depicted in the accompanying drawings. The embodiments are in such detail as to clearly communicate the disclosure. However, the amount of detail offered is not intended to limit the anticipated variations of embodiments; on the contrary, the intention is to cover all modifications, equivalents, and alternatives falling within the spirit and scope of the present disclosure.

In the exciting world of competitive gaming, we often see important details displayed for everyone to see. For example, in games where players have a limited number of chances to stay alive, like shooting games or adventure games, we can see how many chances each player has left. This adds to the tension and makes the game more thrilling to watch. When players are racing against each other, it's helpful to know who's in the lead and who's falling behind. This is shown on the screen or status lights so everyone can keep track of who's winning. Some games give players special powers or abilities or penalties. When these powers are used, it's cool to see them in action. Displaying this in real-time lets us appreciate the skills of the players and add excitement to the game. In competitive gaming, how fast and accurate players are matters a lot. We can see how quick and precise each player is, which helps us understand how well they're doing. In games with time limits, it's important to know how much time is left. This adds pressure and makes the game more intense as players try to finish their goals before time runs out. Lastly, there's the scoreboard, which tells us who's winning. It's like keeping score in a game of basketball or soccer. It helps us see who's doing well and who needs to catch up. Using augmented reality, we can make all this information even cooler by adding it directly onto the game screen. This makes the game feel more real and exciting for everyone watching.

In gaming scenario, players wear helmets or sit in go-karts or other vehicles outfitted with personal screens, typically LED displays or status lights. These screens or lights serve as a portal into the virtual world, providing players with crucial information that can significantly impact their performance and strategic decisions. First, the screens display fundamental attributes such as the number of lives remaining for each player, akin to health points in traditional video games. This information is vital as it directly influences a player's survivability and ability to stay in the game. Additionally, players can see their current position in the race, enabling them to gauge their progress relative to their opponents and adjust their strategies accordingly. Moreover, the screens serve as a conduit for communication between the game environment and the players. For instance, if a player incurs a penalty, such as being “shot” by another player or passing through a designated penalty zone, the screen reflects this by showing effects indicating the player's temporary disablement or slowdown. Furthermore, it displays the duration of the penalty, allowing players to strategize their actions based on how long they'll be affected. Importantly, the screens also show the players'gaming names, which aids in player recognition, particularly in large-scale events where participants may not be familiar with one another personally. This fosters a sense of identity and connection between players and the audience, enhancing the overall experience.

The term “Phygital” encapsulates the fusion of physical and digital elements within the game environment. This encompasses physical aspects like speed, position, and bumps, coupled with digital components such as power-ups and status indicators. For example, when a player obtains a defensive power-up while another acquires an offensive one, it creates a dynamic interplay of strategies as players strategically time the activation of their abilities for maximum impact. In the context of multiplayer races, certain power-ups can dramatically alter the course of the game. For instance, a “ray” power-up may allow a player to disable the cars of their opponents temporarily and take one live per rival without a “shield”. This creates anticipation among spectators as they await the strategic deployment of such abilities and speculate on their potential consequences for the race's outcome. Similarly, acquiring a “star” power-up might grant a player the ability to take a shortcut in a race or take double lives from the rival in a deathmatch battle, providing them with a significant advantage and potentially reshuffling the leaderboard. By exposing spectators to such information, they become more engaged and invested in the unfolding narrative of the game, transcending traditional modes of passive viewership.

In the innovative Battle Mode described in Patent '995, players engage in a thrilling competition reminiscent of bumper cars, where the primary objective is to outlast opponents and emerge as the sole survivor. Building upon the personal screen concept outlined previously, this mode utilizes the displayed information to inform strategic decisions and target selection. Each player's personal screen or status lights showcases critical details such as the number of lives remaining and the amount of ammunition available. Armed with this information, players devise their strategies, determining whom to target based on their current status. For example, players may opt to focus their attacks on opponents with fewer lives or limited ammunition, increasing their chances of eliminating them from the competition. As the battle unfolds, dynamics shift dynamically, prompting players to adapt their tactics accordingly. Initially, all players may start on equal footing, but as the game progresses, strategic considerations come into play. Players may strategically aim to eliminate opponents with fewer resources, thereby thinning the competition and increasing their own chances of survival. This strategic element adds layers of complexity and excitement to the gameplay, as players must constantly assess the battlefield and make split-second decisions to gain the upper hand. By leveraging the information provided on their personal screens, players can formulate nuanced strategies tailored to the evolving dynamics of the battle, ultimately aiming to outmaneuver and outlast their rivals to emerge victorious.

In an aspect of invention, a token system adds an intriguing layer of engagement to both race and battle modes, allowing spectators to actively participate and influence the outcome of the game. Through this system, members of the public are given the opportunity to purchase tokens, powers or extra lives for specific players, injecting an element of excitement and empowerment into the gaming experience. In both race and battle modes, spectators can purchase tokens that grant additional powers or lives to their chosen player or simply affect the race or battle depending of the kind of game mode. This creates a dynamic interaction between players and spectators, as the latter can directly impact the course of the game by supporting their favorite competitors or strategically assisting those perceived as underdogs. For example, in race mode, spectators may opt to purchase a speed boost for a particular racer, providing them with a temporary advantage on the track. Alternatively, in battle mode, tokens could be used to grant extra lives or powerful weapons to players facing imminent elimination, leveling the playing field and prolonging the intensity of the competition. This capability not only enhances spectator engagement but also fosters a sense of community and camaraderie among fans. By allowing spectators to actively support players in real-time, the gaming experience becomes more immersive and inclusive, transcending traditional boundaries between players and audience members. Furthermore, this system introduces strategic considerations for both players and spectators alike. Players must adapt their tactics to account for the potential intervention of token-powered enhancements, while spectators must carefully allocate their tokens to maximize their impact on the game's outcome.

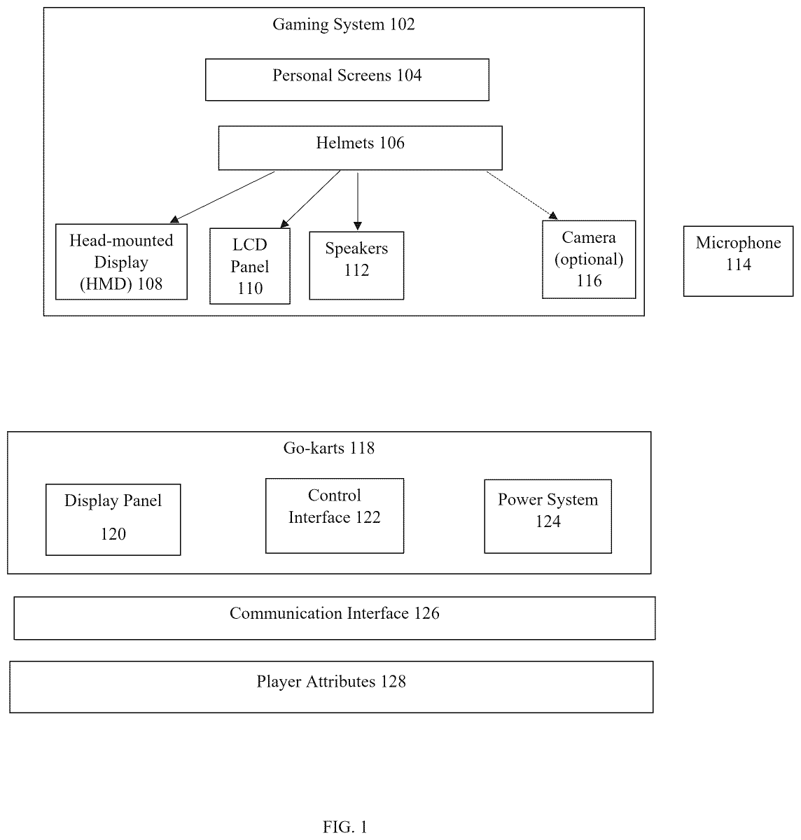

FIG. 1 illustrates various components in the gaming system, in accordance with a preferred embodiment of the invention.

Gaming System (102): The gaming system serves as the central hub orchestrating the entire gaming experience. It integrates all the necessary components to create an immersive and interactive gameplay environment. This includes managing player interactions, coordinating game events, and ensuring seamless communication between players and spectators.

Personal screens (104): Personal screens are integral to the gaming system, providing players with personalized information and feedback during gameplay. These screens are either integrated within helmets or mounted on go-karts or other vehicles, ensuring that players have easy access to essential game data at all times. Personal screens enhance player immersion, allowing them to stay informed and make strategic decisions based on real-time updates.

Helmets or bodywear (106): Helmets are worn by players and serve as a crucial interface for interacting with the gaming system. Equipped with various components, helmets provide players with visual and auditory feedback, communication capabilities, and optional features like augmented reality. By integrating technology directly into helmets, players can fully immerse themselves in the game without distractions. Some of the modules within Helmets are mentioned below:

Head-mounted Display (HMD) (108): The head-mounted display is positioned in front of the player's eyes, providing a visual interface for displaying game-related information. It ensures that players have constant access to essential data such as remaining lives, available powers, and current race position, enhancing their situational awareness and gameplay experience.

LCD Panel (110): The LCD panel is a key component of the head-mounted display, responsible for rendering player attributes and other relevant game information in a clear and concise manner. By presenting data in real-time, the LCD panel enables players to make informed decisions and adapt their strategies accordingly.

Speakers (112): Speakers integrated into helmets deliver audio feedback to players, including game sound effects, ambient noise, and communication with other players. By immersing players in a rich auditory environment, speakers enhance the overall gaming experience and contribute to player engagement and immersion.

Microphone (114): Microphones embedded within helmets capture the player's voice, enabling in-game communication with teammates, opponents, and spectators. Whether coordinating strategies, issuing commands, or engaging in friendly banter, microphones facilitate seamless communication between players, fostering teamwork and camaraderie.

Camera (116): Optional cameras mounted on helmets offer additional functionality, such as augmented reality features or live streaming of the player's perspective to spectators. Cameras provide an extra layer of immersion, allowing players to interact with virtual elements overlaid onto the real world or share their gameplay experiences with others in real-time.

Go-karts or any kind of vehicle (118): Go-karts or other vehicles serve as the physical vehicles used by players in certain gaming scenarios. These vehicles are equipped with components for displaying information and controlling gameplay, enhancing the interactive experience and adding a physical dimension to the game. Some of the modules within Go-karts are mentioned below:

Display Panel (120): Display panels integrated into go-karts provide visual information to players, similar to personal screens in helmets. These panels may show player attributes, race progress, and other relevant data, ensuring that players remain informed and engaged throughout the game.

Control Interface (122): Control interfaces enable players to manipulate their go-karts, including steering, acceleration, and braking. By providing intuitive controls, these interfaces allow players to navigate the game environment with precision and agility, enhancing the overall gameplay experience.

Power System (124): Power systems supply electricity to the components of the go-karts, ensuring their proper functioning throughout the game. These systems may include batteries, wiring, and other electrical components, designed to deliver reliable performance and sustained gameplay enjoyment.

Communication Interface (126): The communication interface facilitates seamless communication between players and spectators, enabling real-time interaction and engagement. Whether conveying game-related information, coordinating strategies, or interacting with fans, the communication interface serves as a vital link connecting all participants in the gaming ecosystem.

Player Attributes (128): Player attributes encompass essential information displayed on personal screens, providing players with valuable insights into their status and progress during gameplay. These attributes may include remaining lives, available powers, current position in the race, and the player's assumed gaming name. By presenting this information in a clear and accessible format, player attributes empower players to make informed decisions and strategize effectively, enhancing their overall gaming experience.

The gaming system incorporates personal screens or status lights within helmets or go-karts to display vital information for each player, enhancing the gaming experience. These personal screens are equipped with LCD displays, showcasing player attributes, including remaining lives, available powers, and current position in the race. Additionally, the player's assumed gaming name is presented on these screens, facilitating recognition and identification during gameplay. The utilization of personal screens as a communication interface allows players to convey information to other players and the public, fostering interaction and engagement. The system integrates physical and digital elements, combining real-world parameters with digital aspects to create a dynamic and immersive gaming environment. This fusion enhances realism and provides players with a deeper level of engagement. Furthermore, the modular design of the personal screens enables players to customize the displayed information according to their preferences and strategic needs. This flexibility enhances gameplay by allowing players to focus on the most relevant data. To enhance realism and immersion, sensors are integrated into the personal screens to detect physical impacts or movements, adding another layer of interaction to the gameplay experience. The user-friendly interface of the personal screens ensures quick access to vital information, minimizing distractions and maximizing player engagement. This intuitive design streamlines gameplay, allowing players to stay focused on the action. Power-up interactions between players are visually represented on the personal screens, fostering strategic decision-making and anticipation among competitors. Players and spectators can track the usage and effects of power-ups like the “boost” or “shield” throughout the race, adding excitement and unpredictability to the gameplay. Additionally, a spectator mode provides real-time access to player information and power-up events, enhancing audience participation and understanding of the gameplay. The personal screens also include interactive elements, enabling players to communicate with each other or trigger in-game actions through gestures or voice commands. This further enhances player interaction and collaboration during gameplay. Finally, the system is configured to synchronize player information and events across multiple personal screens and gaming devices, ensuring consistency and fairness throughout the gameplay experience. This synchronization enhances the overall integrity of the game, providing all players with an equal and immersive gaming experience.

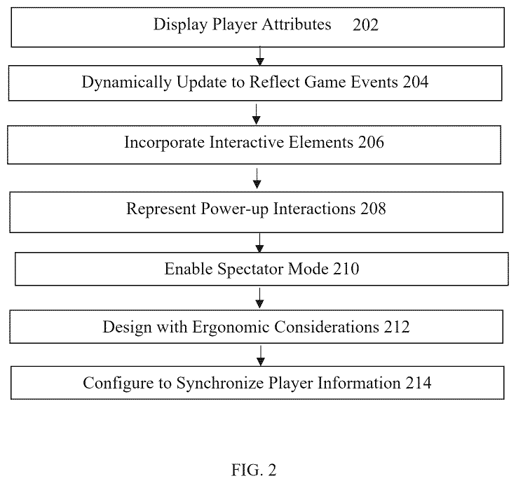

FIG. 2 is a flowchart depicting key characteristic of the gaming system, in accordance with a preferred embodiment of the invention.

At Step 202, Display Player Attributes: This step determines whether the player attributes are displayed in a helmet or over a go-kart. Depending on the setup, the attributes are displayed accordingly.

At Step 204, Dynamically Update to Reflect Game Events: This step involves updating the personal screens in real-time to reflect various game events such as penalties, attacks, and power-up effects. These updates provide immediate feedback to the players during gameplay.

At Step 206, Incorporate Interactive Elements: Players can interact with the gaming system through various elements such as adjusting settings, communicating with other players, or triggering in-game actions. These interactive features enhance the player experience and gameplay dynamics.

At Step 208, represent Power-up Interactions: Power-up interactions between players are visually represented, allowing players to strategize and anticipate the effects of power-ups during gameplay.

At Step 210, Enable Spectator Mode: The gaming system includes a spectator mode that enables real-time access to player information and events for audience engagement. Spectators can follow the game closely and stay informed about the ongoing action.

At Step 212, Design with Ergonomic Considerations: The gaming system is designed with ergonomic considerations to ensure comfort and usability during gameplay. This includes factors such as helmet design, screen placement, and user interface layout.

At Step 214, Configure to Synchronize Player Information: Player information and events are synchronized across multiple personal screens and gaming devices to maintain consistency and fairness in gameplay. This ensures that all players have access to the same information and experience.

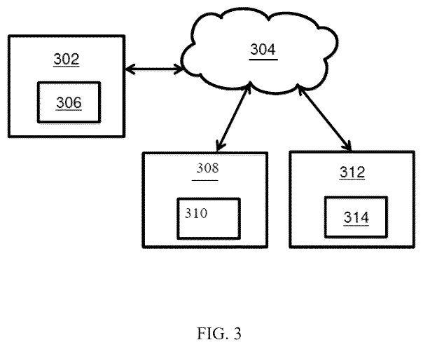

FIG. 3 is a schematic illustration of a gaming system in accordance with an embodiment of the present disclosure. The gaming system comprises a computing arrangement 302 that is connected, when in operation, via a data communication network arrangement 304 to an environmental unit 308 and at least one gaming device 312 that is spatially local to the environmental unit 308. The computing arrangement 302 includes a processor 306. The environmental unit 108 includes a second sensing arrangement 310 and the at least one gaming device 312 includes a first sensing arrangement 314.

While the subject invention is described and illustrated with respect to certain preferred and alternative embodiments, it should be understood that various modifications can be made to those embodiments without departing from the subject invention, the scope of which is defined in the following claims.

1. A gaming system incorporating personal screens display information for each player on said personal screens, comprising:
personal screens equipped with LCD display showcasing player attributes;
player's current status;
presentation of the player's assumed gaming name for recognition and identification purposes;
utilization of the personal screens as a communication interface to convey information to other players and public;
integration of physical and digital elements, encompassing real-world parameters.

2. The gaming system of claim 1, wherein the personal screens are incorporated into helmets, bodywear, go-karts or other vehicles.

3. The gaming system of claim 1, wherein the personal screens employ a modular design, allowing players to customize the displayed information according to their preferences and strategic needs.

4. The gaming system of claim 1, further comprising sensors integrated into the personal screens to detect physical impacts or movements, enhancing realism and immersion during gameplay.

5. The gaming system of claim 1, wherein the personal screens feature a user-friendly interface facilitating quick access to vital information, minimizing distractions and maximizing player engagement.

6. The gaming system of claim 1, wherein power-up interactions between players are displayed on the personal screens, fostering strategic decision-making and anticipation among competitors.

7. The gaming system of claim 1, wherein power-ups like the “boost” or “shield” are visually represented on the personal screens, allowing players and spectators to track their usage and effects throughout the race.

8. The gaming system of claim 1, incorporating a spectator mode that provides real-time access to player information and power-up events, enhancing audience participation and understanding of the gameplay.

9. The gaming system of claim 1, wherein the personal screens include interactive elements, enabling players to communicate with each other or trigger in-game actions through gestures or voice commands.

10. The gaming system of claim 1, configured to synchronize player information and events across multiple personal screens and gaming devices, maintaining consistency and fairness throughout the gameplay experience.

11. The gaming system of claim 1, wherein the player attributes include remaining lives, available powers, and current position in the race.

12. The gaming system of claim 1, wherein the player's current status includes effects such as disablement or slowdown when subjected to penalties or attacks by other players.

13. The gaming system of claim 1, wherein real-world parameters include powerup, position, or lives in game alongside digital aspects such as power-ups and status indicators.

14. The gaming system of claim 1, further including a computing arrangement connected, when in operation, via a data communication network arrangement to an environmental unit and at least one gaming device that is spatially local to the environmental unit, wherein the gaming system is implemented in an environment to emulate an electronic game to play in a physical gaming environment by its one or more users, wherein the gaming system is arranged such that:
at least one gaming device includes a first sensing arrangement for sensing a first information comprising inputs from at least one user while playing the electronic game and generating at least one first event by processing the first information;
the environmental unit includes a second sensing arrangement for sensing a second information associated with the at least one gaming device while playing the electronic game and generating at least one second event by processing the second information associated with the at least one gaming device, wherein the at least one first event and the
at least one second event are provided as input to the computing arrangement;
the computing arrangement includes a processor that, when in operation, implements a set of first rules to determine a modification to at least one of:
a first parameter by processing the at least one first event, or
a second parameter by processing the at least one second event, based on a set of second rules of the electronic game,
wherein the set of first rules comprises programmable compensation rules which cause a hardware reconfiguration of the gaming system based on a status of the electronic game to make the electronic game more competitive; and
generate commands to implement modifications to at least one of:
the first parameter in the at least one gaming device, or
the second parameter in the environmental unit for compensating at least one element of the gaming system for a predefined period of time and for enabling the at least one user to play the electronic game in the physical gaming environment with an improved user experience;
wherein the processor predefines a set of first parameters for the at least one gaming device and a set of second parameters for the environment unit and wherein the processor enables the set of first parameters, the set of second parameters, the first sensing arrangement and the second sensing arrangement in a standby mode before the electronic game starts.

15. A method for enhancing player engagement and interaction in a gaming system comprising:
displaying player attributes on personal screens;
dynamically updating the personal screens to reflect game events to provide real-time feedback to players;
incorporating interactive elements allowing players to adjust settings, communicate with other players, or trigger in-game actions through said personal screens;
representing power-up interactions between players visually on said personal screens;
enabling a spectator mode for real-time access to player information and events;
designing said gaming system with ergonomic considerations;
configuring said gaming system to synchronize player information and events across multiple personal screens and gaming devices.

16. The method of claim 15, wherein the player attributes include remaining lives, available powerups, current race position, and assumed gaming name.

17. The method of claim 15, wherein the game events include penalties, attacks, and power-up effects.

18. The method of claim 15, wherein the personal screens are integrated within helmets.

19. The method of claim 15, wherein the personal screens are integrated over go-karts or other vehicles.

20. The method of claim 15, wherein said game events further comprise collisions between players.
